(19) United States
(12) Patent Application Publication
(10) Pub. No.: US 2007/0038933 A1
(43) Pub. Date: Feb. 15, 2007

(54) REMOTE COACHING SERVICE AND SERVER

(75) Inventor: Marco Luzzatto, Tel Aviv (IL)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Newval-tech Knowledge Services and Investments Ltd.

(21) Appl. No.: 11/464,955

(22) Filed: Aug. 16, 2006

Related U.S. Application Data
(63) Continuation of application No. PCT/IL05/00221, filed on Feb. 23, 2005.

(30) Foreign Application Priority Data
Feb. 25, 2004 (IL) 160,578

(51) Int. Cl. G06F 17/30

(52) U.S. Cl. 715/700; 434/127; 700/90; 707/1

(57) ABSTRACT

A Remote Nutrition Coaching Service (RNCS) is disclosed which is designed for the monitoring and analyzing of personal nutritional behavior and for the increasing of general nutritional awareness. The RNCS provides a daily consumption status and displays the results at the user's convenience. The RNCS also elaborates nutritional information in a way which is easily understandable to the user. Finally the RNCS provides ways for improving the nutritional decision making process in the course of the day and issues real-time notices as for steps necessary for ensuring a balanced nutritional behavior.

### CROSS-REFERENCE TO RELATED APPLICATIONS

This application is a continuation of PCT Application No. PCT/IL20005/000221 filed Feb. 23, 2005, published as WO 2005/079161 A2 Sep. 1, 2005, which claims priority from Israel Patent Application No. 160,578 dated Feb. 25, 2004.

### FIELD OF THE INVENTION

This invention relates to a remote coaching system for guiding persons in carrying out controlled and monitored activities relating to dieting. The system does not require special devices, but is carried out by means of standard individual communication means, and comprises a novel structure of data base and the use of electronic devices that are generally available to individual persons.

### BACKGROUND OF THE INVENTION

The importance of correct dieting is keenly felt by the public in the present times. Devising and following diets by traditional, individual means, is not satisfactory from many viewpoints, and therefore the art has developed a considerable number of methods and devices for assisting individuals in planning and carrying out diets. Some of these methods and devices are particularly intended to achieve health care purposes, while others place the main accent on aesthetic purposes.

WO 02091276 A1 discloses a system for health care administration through the Internet. In this system information about an interested person is received and stored, information is received about cholesterol and glucose levels and obesity indices, and a cholesterol, obesity and diabetes control program is executed., through dietary treatment, drug therapy, diet food ingestion and exercise. The system is complex and its medicinal aspects render it inapplicable for ordinary dieting purposes.

U.S. Pat. No. 5,512,564 discloses a system that consists of a computer for storing and processing nutritional information, a real time clock for maintaining current data record, a product code entry terminal or a bar-code reader for inputting product identification information, a read-write unit adapted to receive smart cards, a printer for printing nutritional information, and optionally an electric display. This system is complicated, requires the concurrent use of a plurality of devices, is difficult to operate by the consumer, and yields only partial data.

WO 0189368 A2 discloses a wrist-mounted device for assisting to maintain a calories balance, which device comprises a processor, a display, a product identifier input mechanism, an activity level input, a resting metabolic rate input mechanism, a data base correlating product identifiers with nutritional data, and a calories management algorithm. The provision of a special device to be carried by the consumer is undesirable and its use is complicated and impractical.

JP 60138671 A2 discloses a menu producer which consists of a magnetic card storing the nutritive value of each dish and calculating menus on the basis of the nutritive balance of each dish. This device has only partial utility because it operates on a generic nutritive value of various dishes and does not take into account the elements of such a nutritive value and their dependence on the producer of the dish. Further, the magnetic card only stores a given database of limited value.

JP 2002149832 A2 discloses a personal computer to be connected to Internet by inserting an exclusive CD ROM of name card size thereto. This system can only be followed by the user of a personal computer and is based exclusively on numerical values provided by a trainer or dietician.

WO 00/58851 discloses a hand-held dietary device for monitoring intake of food stuffs by a user. The device includes memory means storing a database which includes nutritional data, display means, input means, and control processor means. The display means displays the nutritional data on foodstuffs consumed by the user. The database is arranged so that the nutritional data of each type of foodstuff is determined from an inspected volumetric estimation by the user. This system therefore requires a special device to be carried by the user only for dieting purposes, and is based on a highly unreliable estimation of the nutritional data for the various foodstuffs.

It is seen that the prior art systems require the creation of special devices or can only be operated by means of a computer, and are based on generic nutritional values of foodstuffs which are unreliable and anyway do not take into account the influence of the origins of the various dishes. Further, they are awkward to operate and are highly impractical in the every day life of consumers.

It is therefore a purpose of this invention to provide a dietary system which can be carried out by existing devices without causing any complication in the consumers' daily life and which require no complicated processes or data evaluation.

It is another purpose of this invention to provide such a system which takes into account the influence of the different origins of the various food dishes and not merely generic data based on what they are generally expected to include.

It is a further purpose of the invention to provide such a system which involves the monitoring of every important parameter and the constant collaboration of the user and of the system server and database.

It is a still further purpose of the invention to provide such a system which involves the use of generally available electronic devices for receiving and sending information and for displaying it whenever desired.

### SUMMARY OF THE INVENTION

“Coaching”, as this term is used herein, comprises all processes in which a person is guided in performing an activity and provided with information useful to him/her in doing so. In the following description, reference will be made to a process in which a person is informed in matters concerning nutrition and is guided in following an appropriate diet. Since women are generally more keenly interested in diets, the feminine pronoun may be used in referring to said person (generally called “the user”), but it must be stressed that this is done only for convenience and that everything that will be said, applies to men as well.

The invention provides a system which comprises:

(a) Providing a server comprising at least one Remote Coaching Service (hereinafter, briefly, RCS), which comprises a Remote Nutrition Coaching Service (hereinafter, briefly, RNCS).

(b) Providing, storing and adjourning a database including all the data that are pertinent to said RNCS, the nature of which will be generally known to skilled persons and will be further understood from the following description.

(c) Providing for each user an Individual Communication Means (ICM).

(d) In this application the term “RNCS” and “RNCSV” may and will be sometimes used interchangeably as the Remote Nutrition Coaching Service (RNCSV) is, functionally, equivalent and embodied by the Remote Nutrition Coaching Server.

(e) Checking the compatibility of the user's ICM with the RNCS, changing the ICM if necessary, and whenever compatibility is achieved, giving to the user access to the RNCS.

(f) Checking whether a password is needed, and if so, providing it by the user.

(g) Checking whether a profile is needed, and if so, providing it by the user, unless otherwise available.

(h) Choosing by the user the preferred coaching program, if such a choice is needed.

(i) Transmitting to the user the various items of the chosen coaching program, in the appropriate chronological succession.

(j) Monitoring the user's performance and correcting it, where needed.

(k) Updating, when required, the coaching program.

(l) Registering in the RNCS database any new information resulting from the development of the coaching program.

(m) Recognizing the completion of the coaching program

(n) Evaluation of the results of the completed coaching program and suggesting, insofar as appropriate, integration and/or development thereof and/or successive coaching programs.

(o) Allowing the user to acquire, store and access instructional units which contain information relevant to the service.

A particular embodiment of the Coaching Service, as has been said, is the Remote Nutrition Coaching Service (RNCSV), which comprises:

(a) Providing a Remote Nutrition Coaching Server (RNCS);

(b) Storing in said RNCS and updating a database, which includes the relevant generic and specific properties of consumption items (CI) and any personal data of the user and other data, if any, that are relevant to the nutrition process;

(c) Providing for each user an Individual Communication Means (ICI), that is compatible with said Service;

(d) Giving to said user access to said Server; and

(e) Generating and storing in said database, a sub-database, including the user's consumption of food and water along the day and updating said sub-database whenever a consumption occurs.

The consumption items, the properties of which are stored in the database and the consumption of which is stored in the sub-database, include the macronutrients and water, and may further include micronutrients and other substances, if any, relevant to the nutrition process. The amounts of said consumption items are preferably defined as amounts of predetermined components, which generally include carbohydrates, proteins and fats, wherein the amounts of the consumption items stored in the sub-database may be defined as calories.

The Remote Nutrition Coaching Server may also include hardware and software that enable it to process information stored therein or received by it in its operation, in order to derive from it other information that is necessary or useful for carrying out the nutrition process or may be useful to the user in planning and/or carrying out said process or may be desired by said user for any other purpose.

Some specific features of the RNCSV will now be set forth, with reference to the items of the system defined above. Some of said specific features may apply to other Coaching Services as well.

(b) The database for the RNCSV will be called the consumption database and includes, as will be explained hereinafter, a list of the general properties and a list of the specific properties of Consumption Items (hereinafter, briefly, “CI”). It also includes the diet systems that are widely known and recognized and may be called “standard systems”, which may be introduced as subprograms in the RNCSV, and which will become more efficient if they become such subprograms.

The database can be dynamically updated by the entity that runs the primary service or by external source of information that subscribe the service.

(p) A preferred ICM is the cellular telephone. Various types of cellular telephones have different features and different capabilities. Compatibility problems may therefore arise and are addressed in this invention. Another preferred ICM is a cable and digital TV. Even a fix line phone may under certain conditions function as ICM, e.g. while interfacing an IVR (Interactive Voice Response) system.

(q) A profile is generally needed for the RNCSV. It may be available from other sources, and once provided, need not be repeated for any coaching service according to the invention. The profile may comprise items that are fixed (e.g. sex) or can change only slowly (e.g. weight) or can be automatically updated by the system (e.g. age). The user may feel the need to introduce some changes or precisions in the profile and can do so at any time.

(r) In choosing the preferred coaching program, the user may designate a standard program that she wishes to follow, or may ask the RNCS to define a specific program that takes into account some preference of the user.

(s) Monitoring is a central item of the RNCS and may involve a number of particular aspects. The user may request that certain specific subjects be monitored, for instance because they are important for hygienic reasons, or have been requested by a physician, or are related to particular aesthetic problems or desired. On the other hand, the RNCS may decide to pay particular attention to certain parameters because they are suggested by the profile (for instance cardiovascular conditions, past surgery, age, etc., that may place limitations, even strict ones, on the diet) or by the conditions of the user's life (an example of the latter is the close check of the water consumption, if he user lives in an environment or carries out activities that may produce dehydration). Likewise, the user will often select preferred CI's, but the RNCS may decide that the choice is not good and suggest changes, which the user may accept or reject. It may be said, and this is true also for coaching programs other than RNCS, that the monitoring stage generates and involves a collaboration between the coaching program and the user, useful for reaching the optimal results.

The RNCS, as well as other coaching programs, may include selecting by the user an Instructional Unit (IU) and carrying out by the user a practice activity. This stage will be described hereinafter. They further may include accessing by the user one or more external; services.

The term Remote Coaching Server in this application applies to any of the following:
A telephone network server which is an internal or external component of a fix line telephone network;
A server that is part of a cellular phone network;
An Internet server;
A local private network server;
A private telephone network server;
A server that operates an IVR system;
A server that operates a cable, satellite or any kind of interactive TV system;
A server that operates the broadcasting of a radio system;
A server that can mediate between users that are using different individual communication means operating on different systems and is capable of putting the user in communication and allow the users to interact between them and the server and between the users themselves.

A server that allows participation of end users that use different kinds of individual communication means based on different systems, platforms and technologies and that is capable of taking into consideration the limitation posed by some individual communication means in the course of the learning process and that is still able to deliver material in a format that is, at least, partially useable by all or most of the users.

In this application the ICM definition applies of any of the following:
Cellular phones and any kind of mobile phone.
Regular fix line phones with or without messaging features (e.g. SMS).
Internet phones, that is any PC computer that is equipped with modem, microphone, speakers, internet access and suitable software that enable the phone to have internet telephony, voice over IP communications and messaging features such as SMS (Short Message Service), MMS(Multimedia messaging), instant messaging and so forth.
Any device capable of communicating using TCP/IP protocols and HTML, XML, CHTML and HDML, WAP (Wireless Application Protocol) and related ones like.
Personal Digital Assistants (PDA) such as Palm Pilots, Wireless Terminals and such that used alone or in conjunction of another device such, for example a cellular phone, are capable of having voice conversation including internet telephony, voice over IP communications and messaging features such as SMS, MMS, EMS, instant messaging and so forth
TV sets that function as terminals in a cable, satellite or any kind of interactive TV system and that allows the user, employing remote control procedures, to interact with the TV cable system
Local networks terminals, that is, any terminal e.g. phone or pc that are part of a system run locally like a LAN (Local Area Network) or an private office telephone system where the system server is controlled by a private organization and not by the service provider.
Any Java enabled device.
Any device capable of short-range radio transmissions like, for instance, Bluetooth transmissions.
Any device among the mentioned one capable of at least one-way transmission among the ones described (e.g. a TV set capable of only receiving but not of transmitting voice).
Any device that can interact with an IVR (Interactive Voice Response)
One or more of the above mentioned devices, coupled or used in conjunction of another of the above mentioned devices.
One or more of the above mentioned devices, coupled or used in conjunction with computers or communication devices.

### BRIEF DESCRIPTION OF THE DRAWINGS

FIG. 1 shows the interaction with a Remote Coaching Server (RCS) until the moment the actual coaching begins.

FIG. 2 shows the flow of the main sections and processes of the Remote Nutrition Coaching Service (RNCS)

FIG. 3 shows the flow of monitoring processes in the RNCS.

FIG. 4 shows the selection and acquiring process of Instructional Units (IU)

FIG. 5 shows processes and data sources connected with the selection of an Optimal Consumption Unit.

FIG. 6-11 shows an additional preferred embodiment of the RNCS

FIG. 14 shows a sample structure of the RNCS

### DETAILED DESCRIPTION OF PREFERRED EMBODIMENTS

### Embodiment 1

The following embodiment of the invention the operation of the RNCSV (Remote Nutrition Coaching Service) is described. The RNCS is assumed to have been established and provided with all the database required for its operation, as will gradually appear hereinafter.

The RNCS is provided by a Remote Coaching Server (RCSV) that comprises hardware, which is in principle the hardware of a general purpose computer, and comprises the software needed to operate said hardware.

The following embodiment is described in using a flowcharts consisting of several blocks. The order of certain blocks can be altered without changing the essence of the flow and/or the essence of the coaching process. Also, certain blocks may not be required in variations of the embodiment. Finally, some of the blocks could be arranged in parallel and not in sequence depending on how a specific implementation of the invention is carried out, and on whether the program controlling the RNCS is more flow or event-driven. The numerals used hereinafter are those shown in the flowchart.

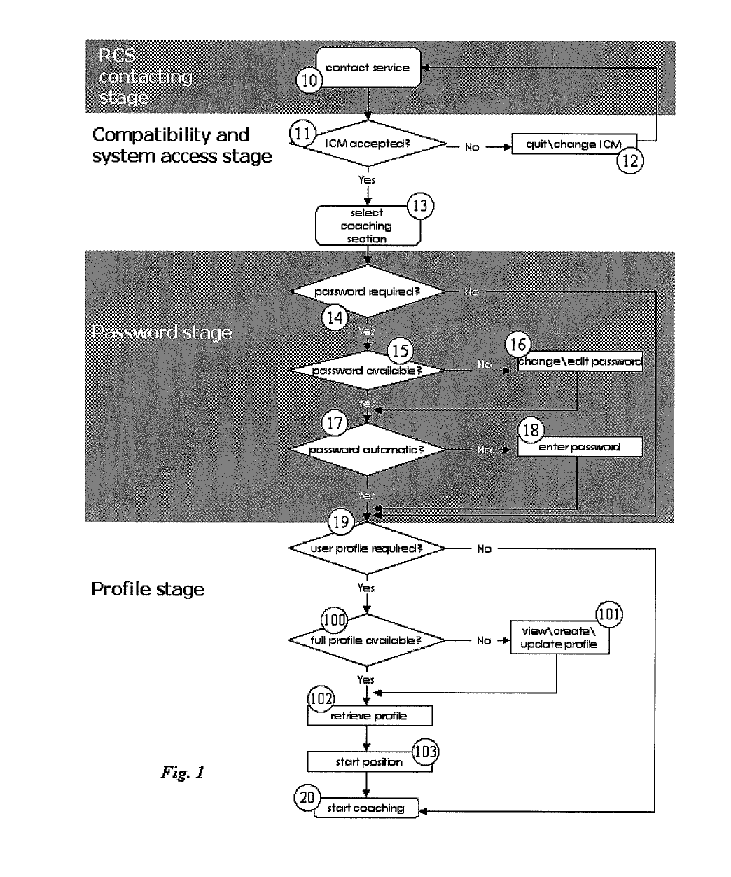

Remote Coaching Service (RCS) Contacting Stage—FIG. 1

(10) The user contacts a service provided by the system server, viz. a RCS. In this embodiment, the service is a Remote Nutrition Coaching Service (RNCS). The means by which the user contacts the RCS is any among a plurality of Individual Communication Means (ICM) (54) as defined before in the application.

The RNCS is assumed to comprise a database containing all the data that will be required to carry out the stages of the process, as will become apparent hereinafter. As already stated, in this application the term “RNCS” and “RNCSV” may and will be sometimes used interchangeably as the Remote Nutrition Coaching Service is, functionally, equivalent and embodied by the Remote Nutrition Coaching Server (53). Furthermore, the term “RNCSV” relates to all hardware and software elements of the server including its database. By “contacting the RCS” is meant a procedure whereby the user sends to the RNCSV a request to access one or all of it services.

Any contacting procedure may be used. For example:

Using a cellular phone in WAP mode, or any other protocol (TCP/IP, Java, etc.) selecting among the various options and services (like online games or information services like news etc.) offered by the cellular provider, an option that activates a link to the RCS. Using an IVR (Interactive Voice Response) system with any kind of phone and interacting with the RNCS using the phone keypad.

Using a digital TV system, selecting a dedicated channel that gives access to the RCS, and then, manually or using a remote control, selecting the specific coaching service: in this embodiment a RNCS.

ICM compatibility and system access stage (11) The RNCS checks for compatibility between the Individual Communication Means, which the user is using, and the system, comprising the RNCSV (53), with which the user is trying to connect.

If the ICM is not compatible with the system, the user is notified (12) and prompted to change ICM and try to connect again.

It must be noted that a specific ICM may be compatible with parts of a given service but not compatible with other parts of the same. For instance, a specific cellular phone may be compatible with parts of the service that are SMS or IM (Instant Message) based, but not be compatible with parts of the service that are MMS-based, if said specific cellular phone does not support MMS.

(yes)→(13) If compatibility is found, the user is given access to the system, viz. to the RNCS (Remote Nutrition Coaching Service).

(no)→(12) If not, the user changes the ICM and tries again, until he obtains access.

Password Stage

(13) The user has accessed the system and can select items from a list of subjects, wherein “subject” means a specific field of coaching. Each subject consists of at least one section and each section consists of at least one Coaching Unit. (CU). Said CU may very in its nature and format and consist, e.g., of an Instructional Unit (IU), which is basically data representing a conceptual chunk of information, or consist of an interactive game-like coaching activity in the course of which creation or editing of personal logs and knowledge records are allowed. It should be noted that if any data are needed at any stage of the coaching process and are not provided, the flow of the process will pause, the user will be required to submit the required data and then the process will resume from the point at which it paused.

(14) Based on said selection, the RNCSV checks whether a password is required for accessing said service or parts of it. If the password is not required, the user moves to the User Profile stage (19).

If a password is required, RNCSV checks for password availability (15).

If a password is available, RNCSV checks whether the password is automatic (17), viz., does not have to be inputted each time anew. If the password is automatic, RNCSV proceeds to the profile stage (19). If a password is available but it is not automatic, the user is prompted to enter said passport (18).

If no password is available or a password has to be changed for any reason, the user is required to create or edit the password (16).

Profile Stage

(19) The RNCSV checks whether a profile is required for accessing the Remote Nutrition Coaching Service (RNCS), or parts of it. A profile is a record containing data concerning the user that is required to provide all the service or parts of it.

The profile, that is stored in the RNCSV database (in short “RNCSV DB”), is a record that comprises a number of fields, each one of them representing a variable. Said variables hold two different types of data: “primary profile data”, directly inputted by the user while using the present service or while using another service provided by the RCS, and “secondary profile data” resulting from processing primary profile data according to certain rules contained in the RNCSV software.

Examples of primary profile data, in the case of the Remote Nutrition Coaching Service, are: height, weight, age, sex, life style (on an active-to-inactive scale), family genetics (on a slim-to-fat body type scale), and optionally, preferred diet program and nutrition style (vegetarian, Scarsdale, low-fat and so forth)

Examples of secondary profile data, in the case of the Remote Nutrition Coaching Service, are: BMI (Body Mass Index) which is calculated by the RNCSV software, user height and weight, user recommended weight, recommended daily calories consumption and so forth.

All the profile data and the rules for deriving calculated data, if any, are assumed to have been stored from the beginning in the RCSV, in this case the RNCSV database.

If a profile is not required, the RNCSV skips to the beginning of the coaching section (20)

If a profile is required, RNCSV checks whether the profile is available (101). If the profile is not available or is incomplete, the system prompts the user to create or edit the profile (101).

If a profile is available the RNCSV retrieves it (102). Then, the RNCSV selects the start position (103). The start position is the beginning of the coaching item requested by the user. Now the coaching stage begins (20).

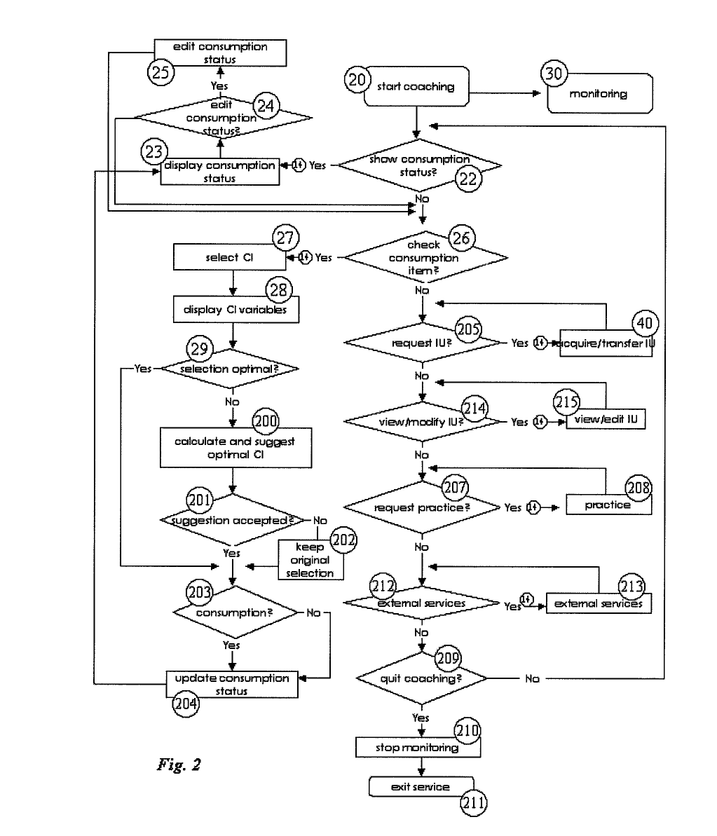

Coaching stage (20)—FIG. 2 In FIG. 2 (30) Monitoring starts at the beginning (20) of the coaching stage. Monitoring consists of a number of processes that, if required, result in active intervention of the system by sending to the user messages and/or different kinds of data, and/or by performing calculations and manipulating information in the database and/or by sources external to the RNCSV (e.g. the Internet) and/or by requesting a response by the user.

For example, the RNCS (Remote Nutrition Coaching Service) periodically checks, the accumulative daily fluid intake of the user. If the fluid amount is not sufficient, the RNCSV (Remote Nutrition Coaching Server) sends a warning to the user and prompts her/him to drink. This warning may be based on data found only in the RNCSV and/or by external data. For instance, if the RNCVS receives from an external data source information about the weather and said information reveals that a given day is a particular hot one, the RNCSV may make use of such information and increase for that specific day the recommended fluid intake amount. Most of monitoring processes are related to user actions but not necessarily dependent on, or synchronized with them.

(22) The user is asked if she/he wishes to check the status of her/his daily consumption, that is, how much food, in terms of calories and/or food groups and/or other predetermined criteria, have been consumed up to that moment.

The presence of (14) indicates in this case and in all following ones in the flowchart that if any part of the profile required to carry out an action requested by the user is missing, the flow of the activity will pause. In this event the user is required to submit the required data and then the program resumes from the place it paused.

(23) The user determines the criteria by which the consumption status is to be displayed or transmitted: by calories or by food groups or both and/or by any other desired criterion. “Transmitted” means herein that the consumption status may not be merely displayed on the ICM display, but can also be sent to an ICM chosen by the user in a suitable format.

The consumption status may be provided for a single day. In this case the user requests “today's consumption status” which is the sum of the calories and/or the amounts of different food groups accumulated in the course of the same day. The consumption status may also be provided for any desired number of days (or on a weekly or monthly base and so forth) and the daily consumption status for each one of them. The user may also request the average consumption status for any specified number of days or unit of time (weekly, monthly and so forth). The data to be displayed is retrieved and/or transmitted from the RNCSV database and, if necessary, further processed by the RNCSV. The consumption status may be displayed in any convenient format (e.g. textual, SMS or graphic format) that is supported by ICM used by the user.

(24) The user can decide to edit the consumption status. This option is used, for instance, when the consumption status was updated prior the an actual food item consumption and then, actually, said consumption did not take place or took place only partially.

(25) The consumption status is edited.

(26) The user is now offered the option to view different aspects of a specific food she/he is considering eating or has eaten and wishes to learn about. For the sake of brevity, we will refer to such food as “consumption item” or, in brief “CI”. A consumption item is a single food component or a combination of different food components that, in common experience, could constitute a separate and independent food item. For example a slice of yellow cheese alone may constitute the consumption item called “slice of yellow cheese”. A sandwich which is composed of white bread, a slice of ham, a tomato and the same slice of cheese mentioned before, is the consumption item called “white bread, tomato, cheese and ham sandwich”

(27) The user selects a consumption item. The selection may be carried out in any way available in the specific ICM used by the user, including, but not exclusively: entering a name or a number with a keyboard and/or a keypad or any other I/O device, selecting/pointing and or clicking on a graphic object or a link, selecting an item from a menu, performing all the above with a remote control device, as in the case of a digital TV remote control, using voice recognition or voice commands, IVR procedures and so forth. The consumption items are stored in the RNCSV database and arranged according to convenient rules e.g., in alphabetical order.

(28) The RNCSV displays different generic properties (50) of the selected consumption item (CI). By “generic properties” is meant properties that are shared by a typical example of a given CI. For example, 100 grams of chocolate have, in most cases regardless of different manufacturers and brands, a similar caloric value and a similar fat content. Non-restrictive examples of generic CI properties are: name, caloric value contained in a typical helping, weight of said helping, caloric value in 100 gr. of the consumption item, the food category to which the selected item belongs, and priority index of the selected item according to the food pyramid and/or to the preferred diet and/or to nutrition style.

The RNCSV may also display specific properties (51) of the selected CI.

By “specific properties” is meant properties that are peculiar to a specific instance of a given CI. For example, the CI “hamburger” has the generic property of “caloric value in 100 gr.”, that will in most instances close to the caloric values of hamburgers that are found on the market. On the other hand, specific properties of said CI comprise “CI provider” and “CI location”, which may be respectively, for example, “Mac Donald” (the provider) and, correspondingly, the location at which Mac Donald's hamburger can be purchased, e.g “Manhattan Mall”. Other, non-restrictive examples of specific properties, may be the price of the CI and the hours in which it can be purchased at a specific location. All generic and specific CI properties are stored in the RNCSV database.

It is to be understood that, notwithstanding the description in this embodiment, the selection a CI and the display of properties of the same can be organized in several different ways. For instance, the CI location property may be searched before the CI provider property, or the opposite. In more complex CI selections than the above one, different order and combination of search criteria, other then the ones herein described, may be used without changing the basic mechanism of the search process.

The CI specific properties can be edited in the RNCSV database in two main ways:
1. By the service provider that runs the Remote Nutrition Coaching Service or
2. By any commercial entity or food provider that manufacture a given CI and is granted by the RNCS service provider access and editing tools to the RNCSV database. Thus, whenever the specific properties of CI change, whoever provides said CI can edit the CI properties in the RNCSV database.
3. In order to do so the commercial entity or food provider accesses the database in any convenient way, e.g. through an internet site or using a dedicated cellular WAP interface to the RNCSV DB or even a simple IVR procedure.

(29) After the selection of the consumption item is complete the RNCSV checks whether the selection is an optimal (52) or a highly desirable one for the user at the selection's point of time.

For instance, the CI may suit the needs of the user in terms of the daily caloric consumption and yet not be an optimal selection because it does not belong to a food group the user should preferably eat or it does not suit the user's nutrition style.

(200) If the selected consumption item is not found to be an optimal or very highly desirable one the RNCSV analyzes the user's profile consumption status and using works out and suggests a better selection.

For example, if the user is still entitled to consume 1000 calories and she wishes to eat 100 calories of cookies after all she ate the same belonged mainly to carbohydrates, the RNCSV may suggest that the user eats a 100 calories fruit salad instead of the cookies.

(201) The user can choose to accept or reject the consumption item suggested by the RNCSV and keep her/his original selection.

(202) If the RNCSV suggestion is rejected, the original selection made by the user is kept.

(203) The user indicates whether a new consumption item has to be added to the consumption status or not.

(204) The RNCSV reconfirms the existing consumption status or updates it.

(205) The user can request an instructional unit (IU) related to (the service she is using, in our case,) the Remote Nutrition Coaching Service. The IU's are described in detail in copending Israeli patents 153757 and 155326 and in PCT application 15786/WO/2. Such IU may be, in this specific embodiment, short elements like terms related to nutrition, e.g. the terms “calorie”, “BMI (body mass index), “cholesterol”, larger element like texts related to the subjects and so forth. The IU may even be movies and documentaries related to the subject. In other words, the same concept can be offered in different IU that vary in the format and extent in which the concept is covered.

For example, the concept “calorie” can be covered in different IU as a simple textual definition, a graphic representation of caloric value in different foods and by a documentary or animation that explains the concept of calories.

(214)-(215) The user has the option to view, edit and manipulate IU as explained in detail in (40).

(40) Managing/handling IU—FIG. 4

The user selects an IU (41) from a list that appears on the display of the ICM used in the course of her interaction with the Remote Coaching Nutrition Service.

The IU that appears in the list can be selected in any way available on the specific ICM.

After the user selects a specific IU, she has to determine the IU format (42).

Once the user has selected the IU format, she has to indicate to which ICM said IU is to be transferred and/or stored, accessed and/activated/edited from—hereafter, the “destination ICM” (43). Conversely, the “initiating ICM” is the ICM from which the selection and transfer command related to the IU is are performed. Destination ICM and initiating ICM may or may not be the same apparatus at all or at stages of the coaching process. In order for the transfer process to be possible, two conditions must be met: the RNCSV must be capable of communicating with the destination ICM (44) and the IU to be transferred (the “source IU”) and the destination ICM have to be compatible (45).

Let us consider for example the case where the user requests the IU “calories”.

Again, as explained before, this IU may be available in a number of formats: textual definition in SMS format, textual definition to be viewed online in WAP mode, Textual definition in ASCII or in similar formats, MMS short movie format, MMS Word format, AVI movie format, HTML format, JAVA format, digital TV program format and so forth.

Now, if we consider the instance of a user having a cellular phone, which is a typical one at the time this application is filed, it is clear that at least some of this formats will not be available to that cellular phone.

The user will be able, for example to view in WAP mode the IU “calories” or receive and store into her handset a SMS which contains the definition of “calories” but she will not be able to view and/or transfer and/or access and view a digital TV program that covers the concept of “calories”.

Considering this limitation the user has two main option for acquiring a IU (both in the commercial and technical sense):
1. Acquire an IU compatible with the initiating ICM for immediate use or later use.
2. Acquire an IU compatible with a destination ICM other than the initiating ICM for later use.

For example, if the RNCS is capable of communicating with a digital TV system, and the user has an account with said digital TV system, the RNCS can inform the digital TV system that the user has acquired a TV documentary related to the subject of calories.

In a later stage, the user can view on her digital TV system set the selected program.

The documentary is accessed by entering, through a suitable interface a personal list of acquired programs using the TV set as an ICM. The list contains links to the TV items acquired by the user and now made available to her, for a certain period or for a number of times—according to whichever commercial arrangement is applied in this specific case—by the digital TV provider.

Obviously, in this case, the IU (the documentary) does not have to be stored in the ICM (the TV set) by they are only accessed through the ICM and stored at the digital TV provider's server.

In another example the IU consists of a MS Word file containing an article related to calories. The user can instruct the RNCS to send the file to the user's email account at a specific internet service provider, provided that such service provider is in communication with the RNCS. Later, the user may download the file to her computer and access it.

In this case, unlike in the previous one, the IU is physically stored at the end of the process in the user ICM itself (her PC).

To conclude, the term “destination ICM” relates to:
an ICM capable of transferring (47), storing accessing/viewing and editing the IU. This case will be referred to as “physical transfer” (46).
an ICM not capable of storing the IU but capable of communicating with a server that can store the IU and being said ICM capable of accessing/viewing and editing the IU stored in said server. This case will be referred to as “logical transfer”. Logical transfer is similar to the creation of a link (48) to the actual IU creation in the RNCS. The RNCS in this case mediate between the Usage ICM
an ICM capable of storing the IU and capable of communicating with a server that can store the IU and being said ICM capable of accessing/viewing and editing the IU stored in said server and also capable of transferring the IU from the server to the ICM itself and further of accessing/viewing and editing the IU transferred from the server to the ICM. This case will be referred to as “two-stage transfer”. A simple example of this last case would be a computer in a network that is capable of transferring files form and to the network server and of editing them.

After the IU transfer is completed the is given the choice whether to select another IU (49) or quitting this RNCS module (400).

(207) At this point the user can request to initiate a practice activity related to the service she is using, in this example, the Nutrition Coaching Service. The aim of the practice activities are: to reinforce the acquired knowledge, to perform self-test and/or instructor-controlled test, to receive feedback as for the proficiency in the studied matter and simulate realistic situations connected to the subject matter of the Coaching Service.

Few non-restrictive examples of practice activities are follows:
1. The user sees on the display of her ICM a multiple choice list of questions for, instance:
   “a calorie is a unit of”: (a.) weight (b.) work (c.) energy. (d.) length The user must select the correct answer using any appropriate selection tool available on her ICM.
   In this, as well as in all the following activity examples, the RNCSV can analyze the performance of the user and supply a feedback (e.g. inform her of the success percentage).
2. A number of images portraying different foods are shown on the ICM display.
   The user is required to select the food items that form a meal that conforms with certain requirements, for example, a low fat meal under 700 calories with high fiber content.
3. The previous two sample activities and similar ones, can also be carried out interacting with one or more other users and/or instructors who are logged into the Remote Coaching Nutrition Service at (RNCS) the same time and may be designed in a game or competition-like manner, allowing the users to challenge each other on knowledge and proficiency.

Role play—additional forms of RNCS activity, may have a behavioral and psychological dimension geared to improve the emotional, rather than the cognitive aspects of the user.

For example, a user having a digital TV set as ICM, interacts with a program that simulates a waiter offering her foods which are not recommended according to the user profile. The user hears and sees the waiter on the TV set and has to reject, using the TV remote control, unsuitable foods and select to suitable foods that appear on the screen.

The results of the practice activities are stored in the RNCSV database and may be analyzed to supply information about the user history and performances in the course of the coaching program.

(208) The practice takes place.

(212) The user may decide to connect to a list of external services.

By “external services” with refer to services which are not part of the coaching program and may even be external to the RCSV in that it only provides a gateway to these services.

For instance, an internet chat concerning nutrition, not provided by the RCS and belonging to a different service provider other than the one running the RCSV represents an example of external service.

(213) The external service is accessed.

(209) The user has the option to quit the Remote Nutrition Coaching Service.

(210) Background monitoring processes that begun in (31) stop.

(211) The user exits the Remote Nutrition Coaching Service.

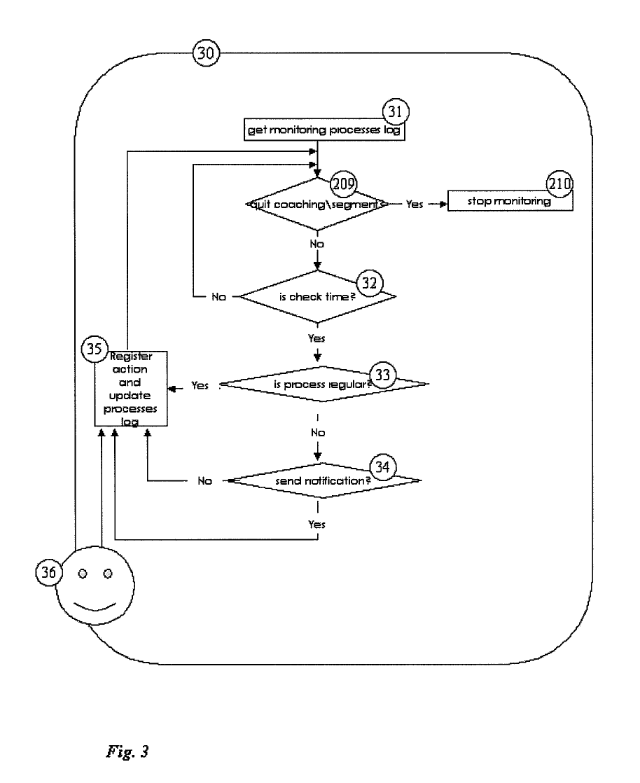

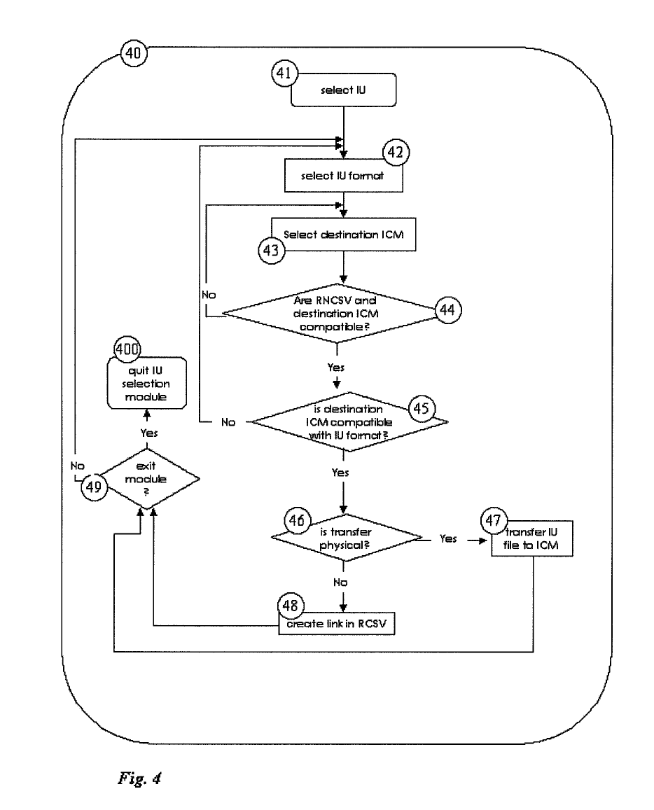

Monitoring (30)—FIG. 3

Monitoring (30) consists of a number of background RNCSV activities that, if required, result in active intervention of the system by sending to the user messages and/or other forms of data, and/or by performing calculations and manipulating information in the database and/or by requesting a response by the user Monitoring processes may last for all the length of the coaching session or may be restricted to certain portion of it according to their relevance. Now, the monitoring process begins.

(32) The RNCSV refers to the monitoring processes log (31) which contains the following information:
The list of processes to be monitored.
For example, “Daily fluid intake” is a typical process in the Nutrition Coaching System.
This process monitors the amount and characteristics of liquids that are drunk by the user in the course of the day.
A “Daily food intake” process would monitor the amount and characteristics of solid food consumed in the course of a day.
Monitoring process does not only relate to the amount and characteristics of nutrition but also to timing, that is, how the consumed amounts are distributed in the course of the day.
Other monitoring processes may be related to other issues that have an influence on nutrition although they are not strictly nutritional issues per se.

For instance, the RNCS may use information about the weather. So, if the day when the user accesses the service is a very hot one, the monitoring unit of the RNCS, (the part that is in charge for monitoring processes) may issue the user a message that reminds her to drink enough water.

The time cycles of said processes.

Using the above mentioned example of the daily fluid intake monitoring process, the monitoring cycle may be, for instance of 4 hours.

In other words, every four hours the monitoring processes unit will check in the processes log the hour and amount of the last fluid intake. If the fluid intake is found to be lacking the monitoring unit will issue to the user a reminder to drink the necessary amount of liquids.

The updated status of the processes.

The process status contains the process name, a record of the actions taken by the monitoring unit, the user actions relevant to the process, the user response to monitoring unit actions as conveyed through the user ICM, the RNCSV response to them, the time cycles. The process log, can be stored on a daily and/or any other unit of time bases.

The data contained in the process log, may be a temporary and volatile one or stored permanently in the RCSV database (which can be in one or more specific hardware and software units.)

Bearing in mind the above mentioned facts, and the fluid intake example, drawing 3 shows:
The monitoring process begins (30) and the coaching service or a segment of the same to which the monitoring processes are related, are in use by the user. The data contained in the process log is loaded (31).

The monitoring unit checks whether the user wants to quit the coaching\coaching segment (209). If affirmative, the service is terminated (210). By “service terminated” we refer to the fact that the user has decided to end her session of Nutrition Coaching Service and not that the RCS has altogether terminated the service.

The monitoring unit checks periodically, if according to the time cycle value found in the process log, it is time to inspect the process status (32).

If it is time for doing so, the monitoring unit checks weather the process status is regular (33).

If affirmative, it updates the process log (35) and then the monitoring cycle begins again, that is, the monitoring unit is in idle mode until is again time for a new evaluation of the process status.

(34) If necessary a notification that a user action is needed (e.g. prompting for drinking more water) is sent to the user using any format convenient for this purpose, depending on the ICM employed by the user (36).

At any point of the monitoring processes, user actions relevant to the monitoring process, are registered in the process log which is then updated. It goes without saying that the user has to inform the RNCSV of her actions using her ICM in order for the RNCSV to know that such action was taken.

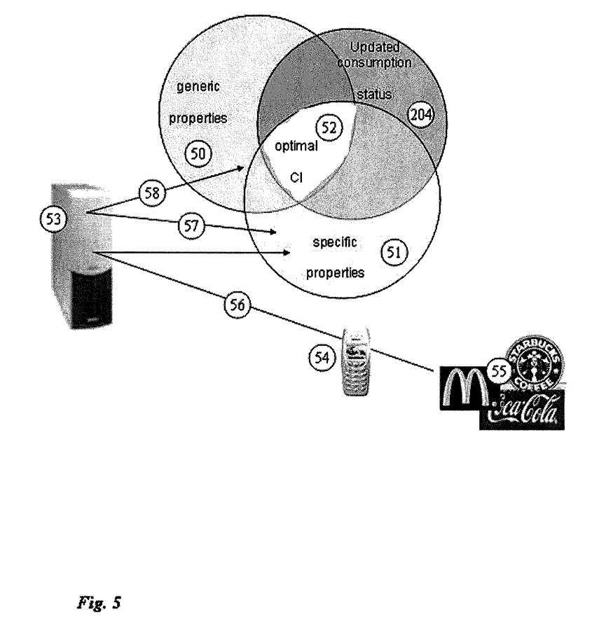

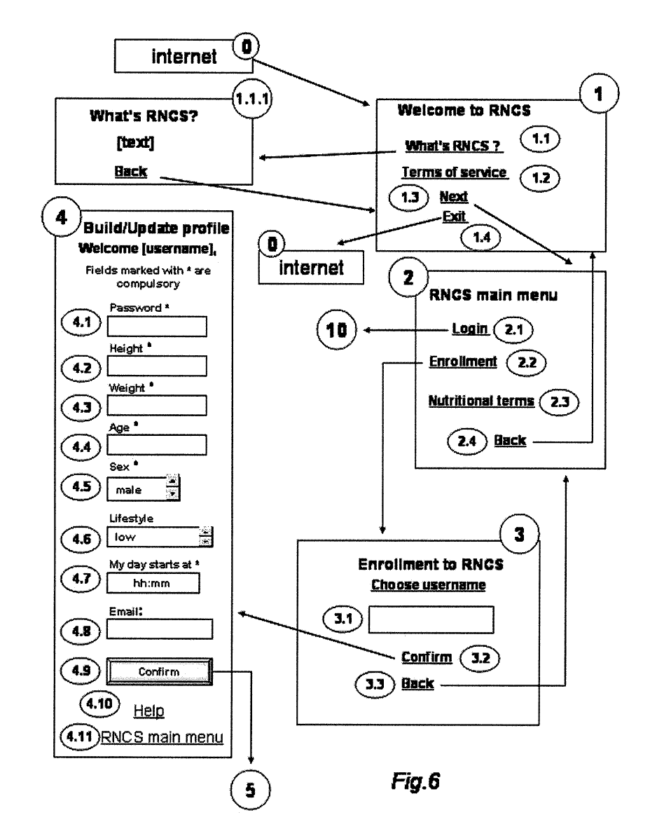

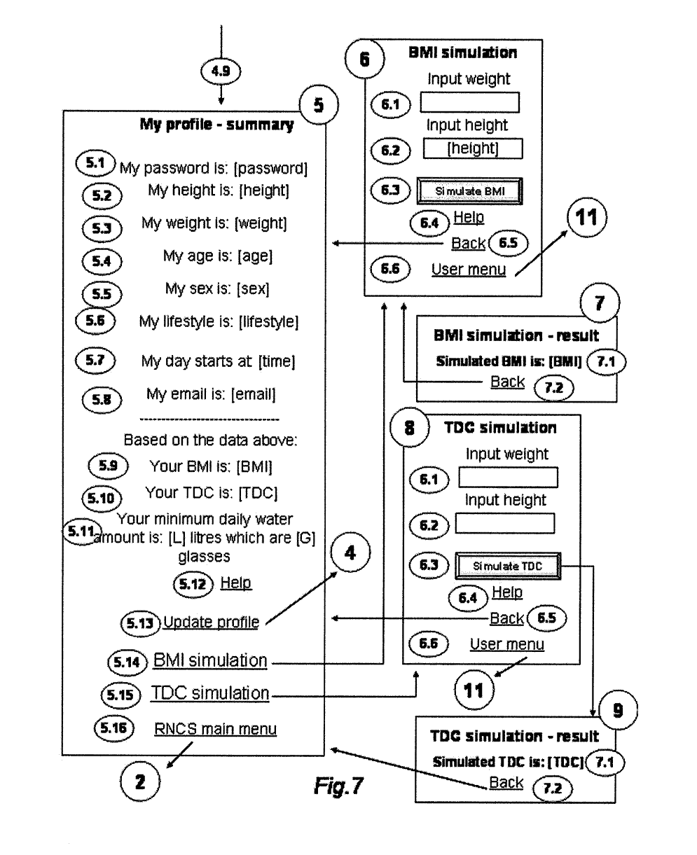

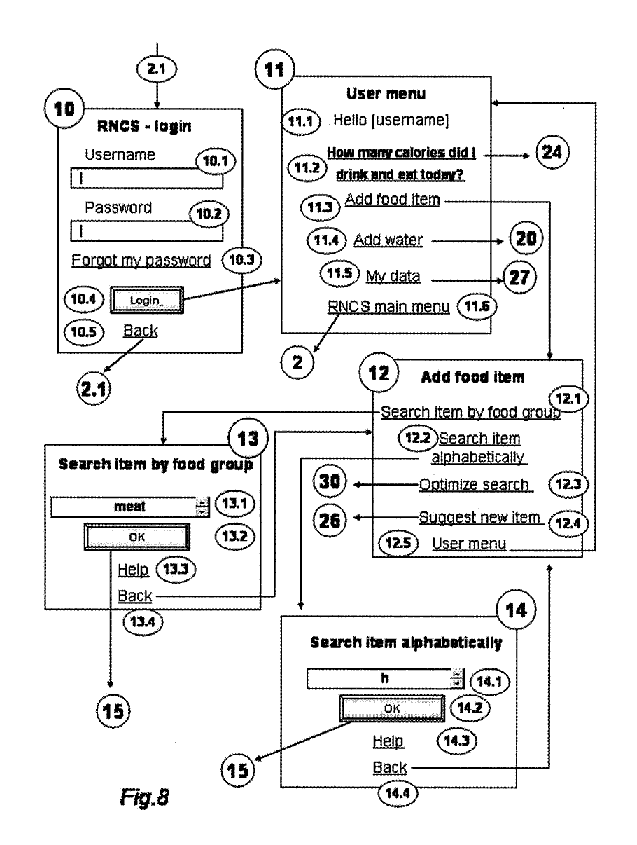

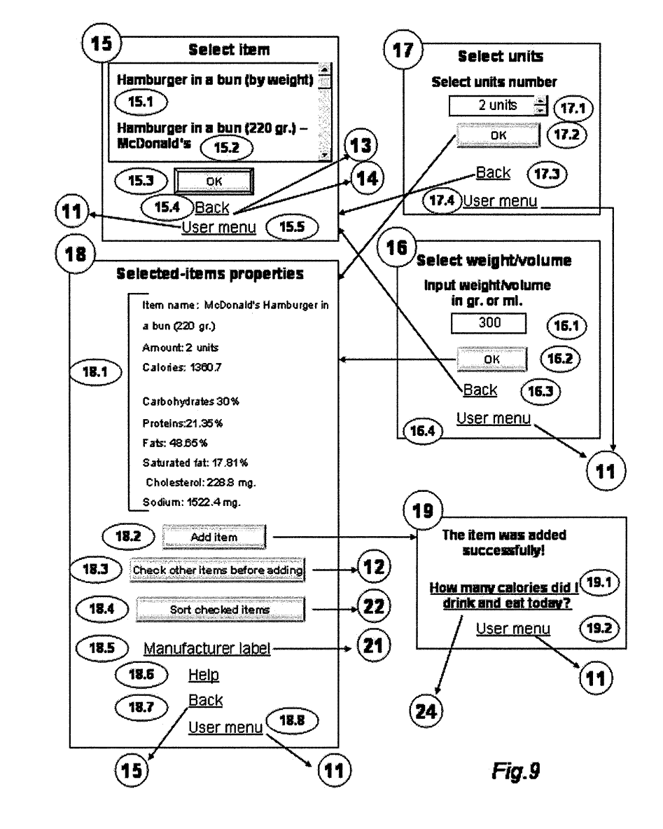

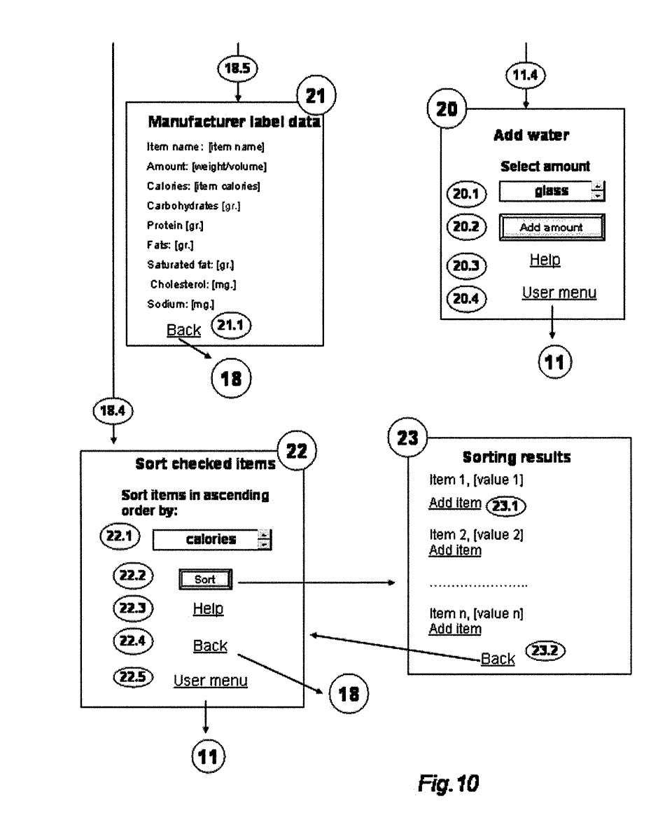

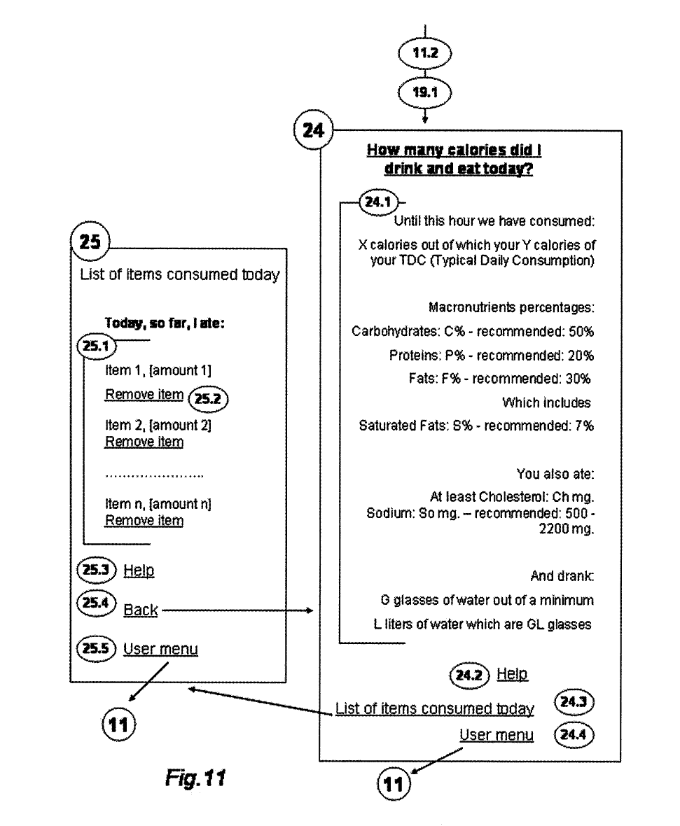

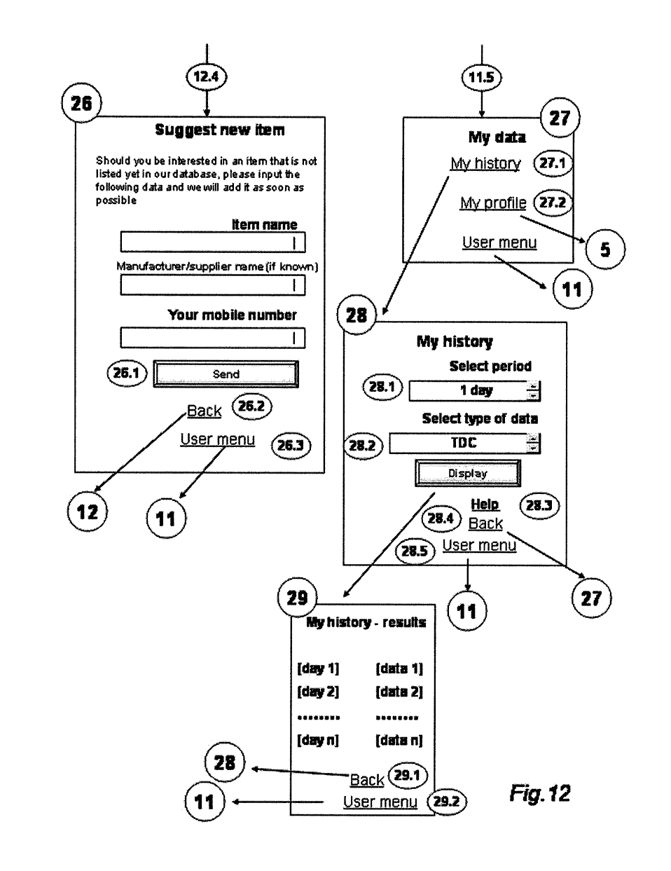

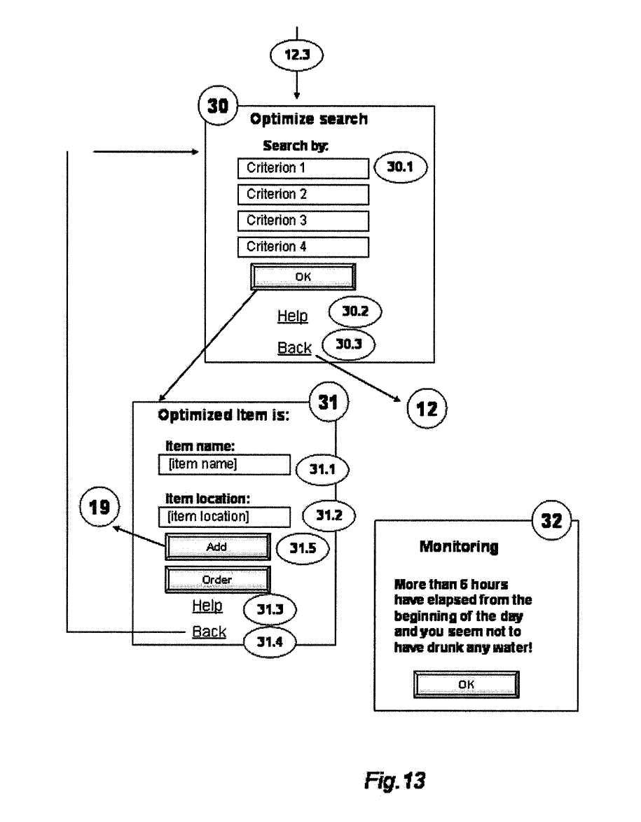

Optimal Consumption Unit (CI) Selection (52)—FIG. 5

FIG. 5 shows the selection process of an optimal consumption unit. Optimal CI selection (52) is represented in FIG. 5 by the area resulating by the overlapping of generic CI properties (50), specific CI properties (51) and updated consumption status (204).

The data of generic CI properties (50) is, typically but not exclusively, provided (58) by the RNCSV (53).

The data of specific CI properties (51), could also be provided (57) by the RNCSV (53) but, typically will be provided (56) by the food providers and manufacturers themselves, symbolically indicated by (55).

Said food providers and manufacturers (55) can update and edit, specific CI properties (51) using any ICM (54) capable of communicating with the RNCSV (53) through a suitable interface.

### Embodiment 2

This embodiment of the invention describes a system and service enabling recording, monitoring and analysis of personal nutritional behavior and increasing of general nutritional awareness which will be called RNCS (Remote Nutrition Coaching Server). It is stressed that the terms “server” and “service” are to be construed, in this context, as being synonymous and can be used interchangeably. The term “server” and “service” also include all the data and software necessary for carrying out the described embodiment. This embodiment is not a diet and although, it might be used also by a dieting person.

General Remarks

Before we begin the description some general remarks must be made:
1. The invention relates to a cross-platform system capable of using any ICM (Individual Communication means), IU (Instructional Units) and Virtual Examination Rooms and other elements as described in Israeli patents 155326 and 153757 and PCT application 15786/WO/02 which are hereby entirely incorporated by reference.
2. The data can be created, stored and updated in one of the following way:
   a. In the server,
   b. in the ICM, e.g. a cellular phone and/or in a memory card coupled with said ICM.
   c. The data can be created, stored and updated in part in the ICM and in part in the server.
3. Specific software necessary for carrying out the embodiment can be located:
   a. In the server,
   b. in the ICM
   c. the software can be located in part in the ICM and in part in the server.
4. The service can be carried out:
   a. entirely online, that when ICM and server are I communication.
   b. entirely offline and, even, having the ICM acting as its own server
   c. Partially online and partially offline. A non limitative example of this last option is running the service offline and updating the data online.
5. For the sake of simplicity the following description is WAP embodiment of the invention but all has being said above remains valid.

FIG. (6)

What's RNCS?

Now the user enters the RNCS site. Bracketed FIG. (1) to (32) indicate, each, a different screen that contains a number of items. For instance, screen (1) contains items (1.1), (1.2), (1.3) and (1.4).

In the description text this notation will also indicate the corresponding paragraph related to said screen.

A preliminary formal observation must be made: The graphic representation of the screen of this embodiment of the invention and all the elements used herein, are described in a non-limitative way and are just some of the many different ways in which the same representation could be created without changing the meaning and substance of the embodiment. The same consideration is valid among other things, for all values, units of measurement, formulas, variables, parameters, ranges, screens and/or program order and/or flow, algorithms, data and terms, ICM, hardware and software configurations which are all used in the description of this embodiment for the sake of example and in a non-limitative way.

The indication “(text)” means that some portion of text that is not explicitly reported here is to be considered as displayed in the screen.

Now, in item (1.1) the line underlining the words “What's RNCS?” indicates that this text is an hyperlink and not a just simple text. The same consideration is valid for the rest of the description of this embodiment.: underlined words are always to be interpreted as hyperlinks (which will be called interchangeably “hyperlinks” or, simply, “links”). These hyperlinks lead to another screen. In some cases, the screen linked to the hyperlink will be merely a textual screen for the purposes of displaying some information and contain just the “Back” option returning to the previous screen. This kind of screen will be referred to as “info-screens”.

Screen (1.1.1) is an example of info-screen. Among other things, all screens that can be viewed by activating a “Help” hyperlink are info-screens. Info-screen will no be graphically represented (except for the example of (1.1.1.)) in this description, as their content is quite self evident and the hyperlinks that lead to such info-screens are self-explanatory.

(1.2)—Hyperlink to info-screen with Terms of Service.

(1.3)—Hyperlink that leads to screen (2)

(1.4)—Hyperlink that allows to quit the site.

Obvious navigation hyperlinks will not be commented upon anymore but an arrow will indicate where they lead to, by pointing to the destination screen or to the number of the destination screen. All this, with the exception of info-screens as they do not require such clarification.

We will now proceed with the description of the screens and the elements. that constitute them. Elements that are self-explanatory will be merely listed with no further elaboration.

(2)—RNCS main menu

(2.1)—starts login procedure for enrolled user.→(10)

(2.2)—starts enrollment procedure (4) for new user.→(3)

(2.3)—leads to an info-screen that contains definitions of nutritional terms used in the RNCS.. Examples of such terms are: BMI, BEE, calories, vitamins, carbohydrates, fats, proteins, cholesterol, sodium etc.

These terms can also be handled and/or acquired as IU (Instructional Units) as described in Israeli patent 155326 and the other incorporated references.

(3)—Enrollment to RNCS

(3.1)—text box for input for username. The words “text box input for” will not repeated and are to be considered as obvious for all following analogous rectangular shapes.

(3.2)—confirmation of chosen username→(4). The arrow symbol points here, and in all its following occurrences, to the screen to which the selected command (or link, or option) leads to.

(3.3)—Back→(2)

(4)—Build/Update profile

This screen is a form that must be filled in by the user in order to build a profile necessary to enable the RNCS functioning and service.

(4.1) Password—password chosen by the user.

(4.2) Height—user's height. 140 cm.≦height≦210 cm. Δ=0.5 cm

(Δ=minimal increment)

(4.3) Weight—user's weight. 37.24 kg..≦height≦132.3 kg.. Δ=0.001 kg.

(4.4) Age—user's age. Age≧18. Δ=1 year.

(4.5) Sex—user's sex selected from a list box.

(4.6) Lifestyle—user'e lifestyle. Relates to the five degrees of physical activity that can be selected from a list box that has five options: very low (degree of physical activity), low, average, high, very high.

(4.7) My day starts at—user's day start time. The hour may be inputted in a variety of formats and the RNCS is capable of interpreting said formats. For instance, if the user wakes up at 8 A.M he/she may input either 08:00, 8:00, 0800, 800, 8 etc.

(4.8) Email—user's email. Optional, for retrieving forgotten password, and for receiving different kind of notices and information, including RNCS reports related to the user.

(4.9) Confirm—confirmation button. Confirms the data provided by the user. The word “button” will not repeated and is to be considered as obvious for all following analogous button-shaped objects.→(5)

(4.10) Help—help link. Leads to an Info-screen containing explanation about (4). In this and in all following instances, the screen item “Help” is to be construed as a link leading to an info-screen (destination screen) that provides information about the previous screen (origin screen) and containing a return option to the same (origin screen).

(4.11) RNCS main menu→(2)

The RNCS does not accept values that are not within the predetermined range or format and prompts the user to reenter invalid data.

FIG. (7)

My profile—summary

This screen serves the purpose of reviewing the profile data and of displaying some information calculated by the RNCS using the user's data.

Number 4.9 in the oval shape positioned on the arrow pointing to screen (5) indicates that screen (4.9) is the screen from which screen (5) is pointed to. All following numbers in oval shapes placed on arrows have a similar function.

(5.1) to (5.8) display the data previously inputted by the user. A text framed in square brackets (e.g. (password) or (age) indicates that here is displayed the value or text inputted by the user).

(5.9) to (5.11) display results of RNCS calculations based on the user's profile.

(5.9) Your BMI is: (BMI)—displays the user's BMI (Body Mass Index).

BMI is a value that shows where the user is on a slim-to-fat scale.

In this particular embodiment, and only for the sake of example, only BMI values that between 19 and 30 are accepted as they reflect normal non pathological conditions (although BMI=26 is already overweight but not obese). If a user is underweight (BMI<19) or obese (BMI>30) he/she will not be allowed to complete the enrollment procedure. In this case a warning message will be displayed and will urge the user to seek professional and/or medical advice.
BMI=Weight (kg.)/Height² (cm.)×10,000

(5.10) Your TDC is: (TDCI)—displays the user's TDC (Typical Daily Consumption). In this description this term, which relates to calories and is not a formal term, is used to indicate the daily calories amount typically necessary (that is, for most of people who share the same profile characteristics) to preserve the user's weight as it is recorded at that specific point of time in his/her profile. Hence, TDC value is only an indicative value rather then a recommendation to necessarily eat that precise amount of calories.

TDC is calculated differently for male and female users, as follows:
TDC=BEE*activity factor
BEE (BASEL ENERGY EXPENDITURE) is calculated as follows:

For men:
66+(13.7×weight in kg.)+(5×height in cm.)−(6.8)×age)

For women:
655+(9.6×weight in kg.)+(1.7×height in cm.)−(4.7)×age)

Activity factors are calculated as follows:

TABLE 1

| | | Degrees of physical |
|---|---|---|
| Activity factor for women | Activity factor for men | activity |
| 1.3 | 1.3 | very low |
| 1.5 | 1.6 | low |
| 1.6 | 1.7 | average |
| 1.9 | 2.1 | high |
| 2.2 | 2.4 | very |

BEE and activity factors are well know to all professionals in dieticians and there are some variations in formulas values. The ones reported above are only one of the many versions.

For example, the TDC of a man aged 46,175 cm high and weighting 75 kg., is about 2766.97 calories.

(5.11) Your minimum daily water amount is: (L) litres which are (G) glasses—RNCS calculates the minimum daily intake of water in liters ((L)) and glasses ((G)) where a glass is defines as 200 ml.

The amount of water calculated as a function of physical activity and is the same for men and women, as follows:

TABLE 2

| Glasses of water | Degrees of physical activity |
|---|---|
| 8 | 1 |
| 9 | 2 |
| 10 | 3 |
| 12 | 4 |
| 15 | 5 |

(5.12) Help

(5.13) Update profile→(4)

Allows the user to edit in his/her profile.

(5.14)—BMI simulation→(6)

(5.15)—TDC simulation→(7)

(5.16)—RNCS main menu→(2)

(6) BMI simulation

Allows the user to calculate what would be his/her BMI at any hypothetical weight.

(6.1) Input weight—weight based on which the user wishes to calculate simulated BMI

(6.2) Input height—as default value, the user's height as currently recorded in his/her profile is displayed as height is not, in normal circumstances, changeable. The option to input a height value other then the default one is designed to allow BMI calculations of peoples other than the user.

(6.3) Simulate BMI—calculates BMI based on values inputted in (6.1) and (6.2)

(6.4) Help

(6.5) Back→(5)

(6.6) User menu→(11)

(7) BMI simulation—result

(7.1) Simulated BMI is: (BMI)—Displays the simulated BMI

(7.2) Back→(6)

(8) and (9)

Calculate and display simulated TDC in an analogous way to (6) and (7)

FIG. (8)

(10) RNCS—login

(10.1) Username

(10.2) Password

(10.3) Forgot my password—if this option is selected, the RNCS retrieves the user password from the user's profile and sends it to the email address specified in (4.8).

(10.4) Login→(11).

(10.5) Back→(2).

(11) User menu

This is the menu used by enrolled users.

(11.1) Hello (Username)

(11.2) How many calories did I drink and eat today?→(24)

(11.3) Add food item→(12)

(11.4) Add water→(20)

(11.5) My data→(27)

(11.6) RNCS main menu→(2)

(12) Add food item

This menu allows the user to select different food items (which are also interchangeably referred to in this application as “consumption items” or, in short “CI”) inspect and analyze their properties and add them to the daily (consumption) status that reflects the user's nutritional behavior in the course of the day.

(12.1) Select item by food group→(13)

(12.2) Select item alphabetically→(14)

(12.3) Optimize selection→(30)

(12.4) Suggest new item→(14)

(12.5) User menu→(11)

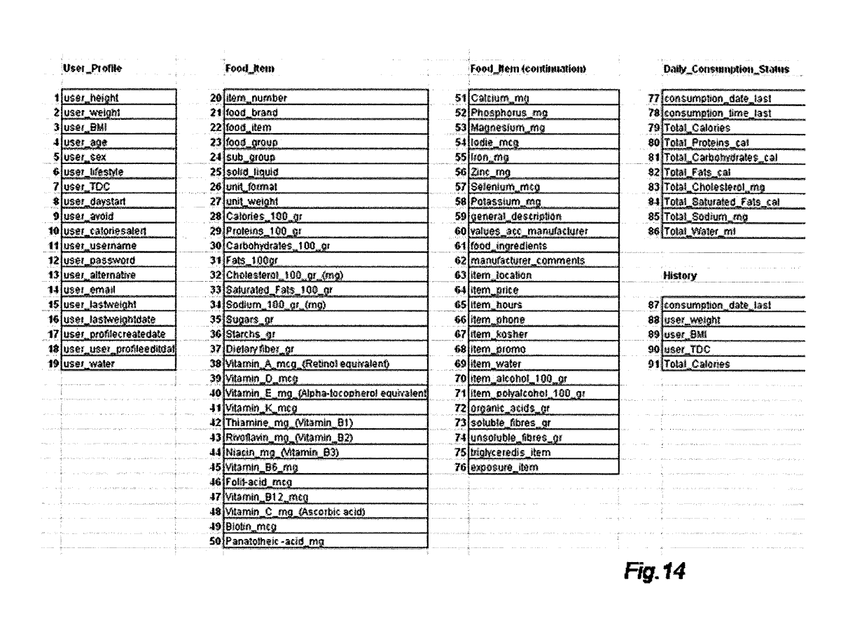

Before the description of the embodiment proceeds it is necessary to describe briefly the RNCS database shown in FIG. 14. Again, as stressed before for other elements of this description, this is only one of the many possible database structures and configurations and is meant to illustrate in a non-limitative way the general principle of said database and its interaction with the RNCS.

RNCS database—FIG. 14

The RNCS database in this embodiment comprises four sections User_Profile, Food_Item, Daily_Consumption_Status, History.

These fours RNCS sections will be also referred to interchangeably as “sub-databases”.

The database can be edited depending on the type of sub-databases:
by the users themselves using their ICM (Individual Communication Means). Examples of user editedable data are: user_height and user_lifestyle (var(1) and var(6)).
by the database administrator or by other authorized parties using a suitable administration interface. Examples of administrator edited data are: food_brand and unit_format (var(21) and var(26)).
by the RNCS itself that edits data elaborating raw data. Examples of RNCS-generated data are: user_BMI and Total_Water_ml (var(3) and var(86)).
by any combination of options 1. to 3.

It is stressed that the verb “edit” applied to RNCS data means both generating new data and also modifying already existing data.

User_Profile

Contains the variables necessary to the user's profile. Clearly each and every user has his/her own storage space in the RNCS which holds his/her profile. Each user has his/her own record in the User_Profile sub-database. The personal record contained in the User_Profile sub-database comprises RNCS variables 1 to 19.

The notation we that will use in the description of the embodiments for these variables is var(x) where “x” stands for the variable index number. For instance, variable “user_age” the index of which is “4” will be indicated as var(4).

The whole RNCS database in this example comprises 91 variables. It must be noted that User_Profile may but does not necessarily have to specify a telephone number (like in this sample database) as the user may access the RNCS from any suitable ICM and the RNCS is not, therefore, limited to a specific ICM. If the telephone number is included, there exists the option to allow automatic access to the RNCS whenever the RNCS recognizes the number but, in this case Username and Password are not required and that enables any person that uses that handset to view and edit the data of the person who is actually enrolled to the service.

Of course, what is the preferable option is a matter of policy and both options are available by this invention.

b. Food_Item

Contains for each food item (which is, in this application, synonymous of consumption item (CI)) a record that comprises var(20) to var(76) that define said food item.

Food Items variables can be divided in four main categories:
1. data that identifies the food item like: food_brand (var(21)) and food_group ((var(23))
The data variables that identify food, relate both to generic CI like, e.g., “pizza” and “humburger” or to specific CI like “Pizza Hut” and “McDonald's humburger”.
2. data variables that relate to macronutrients like: Calories_{—}100_gr and Fats_{—}100_gr (var(28) and var(31)).

Macronutrients are essential nutrients needed by the human body in large quantities for it to fuction normally. They include carbohydrates, proteins, fats, and water. Macrominerals are sometimes included and sometimes excluded from the definition.

In this application we will define Macronutrients as carbohydrates, proteins and fats only. Water will be dealt with separatly as it will be described later on.

3. data variables that relate to micronutrients like: Vitamin_B12_mcg and Biotin_mcg (var(47) and var(49)).

Micronutrients are essential nutrients only needed by the human body in small quantities for it to fuction normally. They include vitamins and trace minerals.

4. Comments and additional information by food manufacturers/providers and by the RNCS administrator regarding generic and specific CI. This information also includes promotional messages and data about specific CI. examples of these data variables are: item_location, item_price and manufacturer_comments (var(63), var(64) and var(62)).

The Food_Item sub-database can be edited only by the database administrator or, as will be seen later, by an authorized party with specific access to a limited portion of the database may edit the database. Said authorized party may be, for instance a food manufacturer and/or supplier who is entitled to edit only his brand items.

The database administration process is carried out using and interface which is a program that displays the relevant database portions and allows them to be edited. The editing process may be carried out form any suitable ICM although, clearly a ICM equipped with a large screen is more convenient for this task.

Daily_Consumption_Status

The Daily_Consumption_Status sub-database contains data about the user's consumption of food and water along the day. All food item contents can be analyzed in terms of the macronutrients, micronutrients and water contained in said food items.

The Daily_Consumption_Status sub-database keeps track of the accumulative amounts of macronutrients, cholesterol, sodium and water as the user eat and drinks consumption items and water in the course of the day and updates the relevant variables whenever a consumption occurs. In fact these variables act as nutrients counters that are dynamically updated In this embodiment we refer as to “consumption items” to items both solid and liquid that carry some nourishing value and, although most foods contain a certain amount of water (var(69)), the RNCS calculate as such only drinking water drunk separately (var(86)).

d. History

The History sub-database contains a record for each day the user has been enrolled to the RNCS. In relation with variables contained in the User_Profile and the Daily_Consumption_Status sub-databases. Each record, that is, each day in the History sub-database, shows what was the value of those variables.

For instance, for each record (=each day) in the History sub-database the Total_Calories variable ((var(91)) show how many calories where consumed in that specific day.

(13) Search item by food group

The user has two methods for searching the desired Consumption Item

(13.1) Shows a list box which contains a list of predefined food groups (var(23)) of the food items present in the RNCS database. Examples of food groups are: vegetables, fruit, meat, sweets, dairy, bakery etc.

The user first selects the desired food group before looking for a specific CI. For example, In example in the drawing, the user is looking for an hamburger and, therefore, the food group “meat” is selected.

(13.2) OK—the user confirms the selection of the food group.→(15)

(13.3) Help

(13.4) Back→(12)

(14) Search item aphabetically

alternatively, the user may search for the food item alphabetically rather than by food group.

(14.1) Shows a list box which contains the alphabet letters from which the first letter of the desired CI name. For example, In example in the drawing, the user is looking for an hamburger and, therefore, the letter “h” is selected

(14.2) OK—the user confirms the selection of the first letter of the CI name.→(15)

(14.3) Help

(14.4) Back→(12)

(12.3) Optimize search→(30)

FIG. (9)

(15) Select item

After the first stage of the search for the item, either by food group or alphabetically, a list of the item names (var(22)) that match the search requirements is displayed. Now the user can make the final selection and choose the desired item.

The list box shows two items that match the search requirements:

“Hamburger in a bun (by weight)” and (15.2) “McDonald's Hamburger in a bun (220 gr.)”.

“Hamburger in a bun” is, a generic CI whereas item b relates to a specific “McDonald's Hamburger in a bun (220 gr.)” is a a specific CI. Specific CI are items that are usually perceived and consumed as a unit with a predetermined size/weight and/or format whereas the size/weight and/or generic items usually are determined by the user.

For the sake of simplicity, we will assume in the following description that these two items have the same nutritional composition but this is not necessarily correct, although it's irrelevant for description's purposes.

(15.2) OK—the user confirms the selection of item→(16) or (17)

(15.3) Back→(13) or (14) depending on the previous step.

(15.4) User menu→(11)

(16) Select weight/volume

(16.1) Input weight/volume in gr. or ml.—If the selected item is a generic CI the user is requested to indicate the amount of CI (weight or volume) that he/she wishes to consume.

The nutritional information is recorded in the RNCS database for 100 gr. or 100 ml. depending on whether the food item is a liquid or solid one (var(25)). Therefore, the user must indicate the desired amount in order to apply the right multiplier (hereafter “CI multiplier”) to the nutritional information. In our example, if the user wishes to eat a 300 gr. hamburger in a bun, the multiplier will be “3”. Hence, for generic CI the CI multiplier equals the desired amount in gr./ml. divided by 100.

(16.2) OK—the user confirms the selected weight/volume→(18)

(16.3) Back→(15)

(16.4) User menu→(11)

(17) Select units

(17.1) Input units number—If the selected item is a specific CI, the weight/volume of the food item is already known (var(27)). Therefore, the user must indicate the number of units in order to apply the right CI multiplier to the (per 100 gr.) nutritional information. Bearing in mind that in our example the specific food item weighs 220 gr. (“McDonald's Hamburger in a bun (220 gr.)”, If the number of units is “2” the CI multiplier will be 2 × specific CI weight/volume divided by 100. That is, 2×220/100=4.4=2×var(27)/100.

(17.2) OK—the user confirms the selected units number→(18)

(17.3) Back→(15)

(17.4) User menu→(11)

(18) Selected-item properties

Once the food item has been selected it is not added yet to the Daily Consumption Status which is the record of what has been eaten and drunk in the course of the day. At his stage the selected food item is, from the RNCS point of view still a “candidate” to be added to added to the Daily Consumption Status. This, because the user may want to analyze the food item properties before actually eating it and maybe compare between different food items in order to choose the most suitable item according to his/her criteria.

At this point some important properties of the selected food item are displayed. In this example the displayed food properties are, besides “item name” and “amount”, a number of food components:

Calories, Carbohydrates, Proteins, Fats, Saturated fat, Cholesterol and Sodium.

The reason that these components (or, as are technically often called “nutrients”) are chosen in this example among the many food properties (“food variables” in the RNCS database we discussed above) is that in most countries they have to be displayed on the product label under health regulations and are considered mandatory nutritional data that must be provided to the consumer. For the sake of brevity we will refer hereafter to this basic nutritional data as to “label data”.

Label data is displayed by law for 100 gr of product in gr., mg., mcg. and ml. according to the case. Also, the manufacturer is required to display the caloric value for 100 gr/ml of product.

Still, this information is not easily understandable by the consumer and poses three major problems:
1. The label data is given by weight or volume measures and the user does not know their corresponding caloric values.
2. Even if the users knew the caloric values they are given per 100 gr./ml and which is not, in most cases the actual amount eaten or drunk by the consumer.
3. In most cases, unpacked food items do not have to carry by law any nutritional data.

These three problems are solved by the RNCS in the following way:
1. the label data is converted from weight/volume to calories
2. The CI multiplier is applied to the converted caloric values.
3. The RNCS database contains the information nutritional data both for packed, brand products and unpacked, generic products.

The process by which label data is elaborated in a form easily understandable by the consumer and displayed in (18.1) will now be illustrated.

TABLE 3

| | 6 | 5 | 4 | 3 | | |
|---|---|---|---|---|---|---|
| 7 | values in 2 | calories | caloric | values | 2 | 1 |
| caloric % | CI units | in 100 gr | factor | (in 100 gr) | unit | food item variable |
| — | | — | — | 220 | gr. | weight = var(27) |
| 100.00 | 1360.7 | 309.25 | — | 309.25 | cal. | calories = var(28) |
| 21.35 | 290.576 | 66.04 | 4 | 16.51 | gr., | proteins = var(29) |
| 30.00 | 407.616 | 92.64 | 4 | 23.16 | gr.. | carbohydrates = var(30) |
| 48.65 | 662.508 | 150.57 | 9 | 16.73 | gr.. | Fats = var(31) |
| — | 228.8 | — | — | 52 | mg. | Cholesterol = var(32) |
| 17.81 | 242.352 | 55.08 | 9 | 6.12 | gr.. | Saturated fats = var(33) |
| — | 1522.4 | — | — | 346 | mg. | Sodium = var(34) |

(a) First we selected the CI (var(22)) that in our example is, “McDonald's Hamburger in a bun (220 gr.)”. Then the CI multiplier was calculated. In our example, since the user is going to eat 2 CI units, the CI multiplier will be 4.4. as calculated in (17.1). The CI multiplier was calculated using the weight of the individual CI unit (var(27)).

(b) Now a conversion from food components to calories has to be operated.

In our example, column 1 of the table shows the food components. Among said components, only proteins, carbohydrates, fats, and saturated fats carry a caloric value. The caloric factor for each of these food components is listed in column 4. The caloric value for 100 gr. is calculated by multiplying each the weight of each ingredient that carries a caloric value (column 3) by its corresponding caloric factor (column 4) and the result is shown in column 5.

(c) Now, that we have the values for 100 gr. we will apply the CI multiplier to find out the values for the actual weight of the 2 CI units (the two “McDonald's Hamburger in a bun (220 gr.)”). As we saw, the CI multiplier in our example is 4.4 as each CI weighs 220 gr. The components that do not carry a caloric value are also multiplied by the CI multiplier because their value is also of interest for nutritional purposes. The result is shown in column 6 that lists the caloric value of each caloric food component in 2 CI units and also the weight of non-caloric food components in said 2 CI units. The measurement units for these food components are listed in column 2.

In column 6 all values are in calories except for cholesterol and sodium (that are in mg.).

(d) Column 7 shows the percentage of each caloric food component in the overall caloric value of the CI.

It must be noted that saturated fat value is already calculated in the fats value but is reported separately, for information sake, because of the importance of saturated fat and its impact on the consumer's nutrition.

If we had selected the second CI option “Hamburger in a bun (by weight)”

And consumed 300 gr of the same, the process would have been similar with the difference that the CI multiplier would have been “3” as explained in (16.1) rather than “4.4”.

In (18) only basic nutritional data is displayed (“label data”) but any food item data var(20) to var(75) can be displayed.

The data to type of data to be displayed can, optionally, be defined by the degree of food item information exposure—var(76).

For example if var(76)=1 only label data will be displayed. If var(76)=2 also all micronutrients will be displayed and if var(76)=3, promotional messages and manufacturers comments will also be displayed.

Therefore, the kind and degree of food information that will be displayed depends mainly on commercial considerations and agreements between food suppliers/manufacturers and the RNCS operators.

(18.2) Add item—the user can add immediately the selected consumption item to the Daily Consumption Status as it will be described later in (20.2)→(19)

(18.3) Check other items before adding—the user can select and inspect other food items and view their properties as he/she did for the currently selected food item, before or without adding the selected food item to the Daily Consumption Status.

If this option is chosen, additional items and their properties will be displayed in (18)→(12)

(18.4) Sort checked items→(22)

(18.5) Manufacturer label→(21)

(18.6) Help

(18.7) Back→(15)

(18.8) User Menu→(11)

(19) The item was added successfully!

Informs the user that the user has been successfully added to the Daily Consumption Status list.

(19.1) How many calories did I drink and eat today?→(24)

(19.2) User Menu→(11)

FIG. (10)

(20) Add water

(20.1)—The user selects the amount water he/she drinks from a list box the items and their corresponding values are listed below.

TABLE 4

| Item | Amount in ml. |
|---|---|
| ½ glass | 100 |
| glass | 200 |
| ½ mug | 150 |
| mug | 300 |
| ½ small bottle | 250 |
| Small bottle | 500 |
| ½ 1 liter bottle | 500 |
| 1 liter bottle | 1000 |
| ½ 1.5 liter bottle | 750 |
| 1.5 liter bottle | 1500 |

(20.2) Add amount—the selected amount of water is added to the Daily Consumption Status.

To illustrate this process, let us assume that one glass of water is added. Var(86) is the water counter in the Daily Consumption Status sub-database. Let us suppose the Var(86), before this addition held the value of 1200 (ml. of water). This will be noted as Var(86)=1200. after adding the glass of water, Var(86)=Var(86)+100. which means that now Var(86)=1300. It goes without saying that this notation, that illustrates the use of the water counter, is made using what is customary in programming languages syntax and it's not the algebraic one, The same consideration is valid also for the consumption counters in the Daily Consumption Status. These counters refer to macronutrients and water and are marked as var(79) to var(86),

(20.3) Help

(20.4) User Menu→(11)

(21) Manufacturer label data

Show the basic nutritional information that is reported on the manufacturer label before weight/volume to calories conversion and before CI multiplier is applied.

21.1 Back→(18)

(22) Sort checked items

The food items selected and displayed in (18) can now be analyzed according to different criteria including: calories, fats, proteins, carbohydrates, cholesterol; sodium. An additional important criterion that can be used is the percentage of deviation from the optimal macronutrient percentage distribution. This subject requires a brief explanation.

Recommended macronutrient percentage distribution in the daily total calories intake is roughly 50% carbohydrates, 20% proteins and 30% fats.

Every time we eat a new food item, this percentage distribution changes according to the contents of the last item. It is very difficult, if not almost impossible for the user, to evaluate which one among a number of possible CI is to be preferred in order to achieve a better macronutrient percentage distribution. The RNCS offers a method and criterion to evaluate the preferred macronutrient percentage distribution at each point of time. This criterion will be called “% by time”.

(22.1) Now, the user selects from a list box the criteria by which he/she wishes to evaluate the potential food items.

(22.2) Sort—the items are sorted according a predetermined order, e.g. ascending or descending. And the results are displayed in (23) from where the user can also add items (23.1) the suits his/her requirements.→(23)

(22.3) Help

(22.4) Back→(18)

(22.5) User Menu→(11)

Before we continue the system for “% by time” criterion will be described. Let's first define the following expressions which relate to the Daily Consumption Status:
T_Cal=Total calories added until now
T_C=Total calories originated form carbohydrates added until now
T_P=Total calories originated form proteins added until now
T_F=Total calories originated form fats added until now
T_Cal_item_x=all calories in item x not yet added
T_C_item_x=calories in item x, not yet added, originated form carbohydrates
T_P_item_x=calories in item x, not yet added, originated form proteins
T_F_item_x=calories in item x, not yet added, originated form fats

For each x “candidate” item which are being checked before adding them we calculate the maximum deviation from the recommended macronutrients percentage distribution by one of the item's macronutrients
Dev_{—}x=Max {|((C/T*100)/50*100−100)|,|((P/T*100)/20*100−100)|,|((F/T*100)/30*100−100)|}
Then, for x=1 to n
We list in ascending order Dev_X

Being the smallest (the first) Dev_X value the one that is Min(Max(Dev(X)) that is, the one with the smallest deviation from the recommended macronutrient percentage distribution.

Alternatively, as another criterion, is also possible to apply the minimum average deviation expressed as
Dev_{—}x={|((C/T*100)/50*100−100)|+|((P/T*100)/20*100−100)|+|((F/T*100)/30*100−100)|}/3
And then, again Min(Dev_X).

Finally, the same concept for evaluating food items with better distribution of food components can be applied to any number of nutrients and not just to proteins, carbohydrates and fats as shown, for illustration, above.

(23) Sorting results

The sorting results are displayed, for instance, in ascending order.

(23.1) Add item→(19)

(23.2) Back→(22)

FIG. (11)

(24) How many calories did I drink and eat today?

Shows in the Daily Consumption Status.

(24.1) All the values Daily Consumption Status variables are shown updated and reflecting the consumption situation at that specific time.

Using the same system shown in (18) and in Table 3 Macronutrients are reported by percentage. Other food components are displayed by weight/volume. “X”, “Y”, “C %”, “P %” etc. represent the updated values at check time.

(24.2) Help

(24.3) List of items consumed today

(24.4) User Menu→(11)

(25) List of items consumed today

(25.1) The user can view the list of all items consumed in the course of the day and can remove items (25.2) if he/she wishes to do so.

(25.3) Help

(25.4) Back→(24)

(25.5) User Menu→(11)

FIG. (12)

(26) Suggest new item

The user can suggest (26.1) to add to the RNCS database and item which is of interest to him/her.

(26.2) Back→(12)

(26.3) User Menu→(11)

(27) My data

(27.1) My history→(28)

(27.2) My profile→(5)

(28) My history

Allows the user to create reports about his/her nutritional behavior and use of RNCS.

(28.1) The period for which we wish to receive the history report is selected.

(28.2) The type of information by which the report has to be issued is selected. This type of information may be, for instance, calories consumed in each day (TDC), average calories per day, days in which a change of weight was registered, etc..

(28.3) Help

(28.4) Back→(27)

(28.5) User Menu→(11)

(29) My history—results

The requested type of data is displayed for the requested period days.

(29.1)Back→(28)

(29.2) User Menu→(11)

FIG. (13)

(30) Optimize search

It goes without saying, that different and/or additional food item serch criteria could be used in embodiments of the invention. For instance, the item could be search for by brand name (var(21)).

In this case the list box would contain a list of different brands. An additional criterion could be the item location (var(63)). In this case the box would contain a list of locations from which the desired location might be selected.

Optionally, the search methods could be cumulative (30.1) rather than alternative. In other words, instead of selecting the item, for instance, by food group or by brand name or by location, the item could be selected, by food group and by brand name and by location. Thus, for example, the user could select first the food group name “poultry”, then the brand name “Kentucky fried chicken” and finally the location “London”. Of course the existence of the specified item depend on weather the RNCS database contains an item that matches all the applied selection criteria.

(30.1)OK→(31)

(30.2) Help

(30.3) Back→(12)

(31) Optimized Item is:

Another useful optional way to carry out the search is to first determine some nutritional criteria as described in (30) and then refine the sarch. For example, the user can first determine the caloric value of the desired item (.e.g. 100<calories<500), then choose the main macronutrient in the desired item (e.g. proteins) and then apply the other criteria.

Lastly, if would be desirable for the user's ICM (in this example a cellular phone) to be equipped with GPS (Global Positioning System) or any other suitable positioning system capable of locating the user's current position, including, for instance, a cellular LAN in a shopping center. In this case, after applying some search criteria the positioning system would spot the closet supplier that has the optimal item.

Such a search criteria sequence could be:
500<calories<700
food group=meat
price<10 pounds now the system would identify the item as “McDonald's hamburger” and the location as “123 Oxford street”.

The data of the final item selection would now appear on the user's ICM display as shown by (31.1) and (31.2).

(31.3) Help

(31.4) Back→(30)

(31.5) Add→(19)

(31.6) Order

This option makes use of a procedure similar to the Virtual Examination Room described in PCT application 15786/WO/02.

This option comprises the following steps:

The ordered item is communicated to the food provider (e.g. a restaurant) either through any suitable protocol or messaging before the user has reached the location or by LAN communication (e.g.) when the user reached the food location.

When the user's ICM reaches the location the user is optionally identified through LAN communication, preferably through a wireless LAN environment or GPS (global positioning system).

The user is, optionally, automatically charged through the user's sevice provider or by sending to food provider data related to credit car or other paying means.

(32) Monitoring

The RNCS checks at predetermined times whether certain conditions are met. If they are not, the user is notified of a situation that requires come actions form his/her part.

For instance, if after six hours from the beginning of the day there is no record of water intake, and appropriate warning is displayed.

While embodiments of the invention have been described for purposes of illustration, it will be understood that the invention may be implemented with many variations, modifications and adaptations, without departing from its spirit or exceeding the scope of the claims. In particular, it may be implemented in the learning of widely different subjects and for widely different purposes.

1. Remote Nutrition Coaching Service (RNCS) which comprises:
a) providing a Remote Nutrition Coaching Server;
b) storing in said RNCS and updating a database, which includes the relevant generic and specific properties of consumption items and any personal data of the user and other data, if any, that are relevant to the nutrition process;
c) providing for each user an Individual Communication Means (ICM), that is compatible with said server;
d) giving to said user access to said service; and
e) generating and storing in said database, a sub-database, including the user's consumption of food and water along the day and updating said sub-database whenever a consumption occurs.

2. System according to claim 1, wherein the consumption items, the properties of which are stored in the database and the consumption of which is stored in the sub-database, include macronutrients and water.

3. System according to claim 2, wherein the consumption items, the properties of which are stored in the database and the consumption of which is stored in the sub-database, further include micronutrients and other substances, if any, relevant to the nutrition process.

4. System according to any one of claims 2 to 3, wherein the amounts of the consumption items included in the sub-database are defined as amounts of predetermined components.

5. System according to claim 4, wherein the predetermined components include carbohydrates, proteins and fats.

6. Remote Nutrition Coaching Service according to claim 1, which includes as subprograms the standard diet systems.

7. Remote Coaching System according to claim 1, wherein Individual Communication Means (ICM) for at least a number of users is a cellular telephone.

8. Remote Coaching System according to claim 1, wherein a profile is needed and comprises items that are fixed, or can change only slowly, or can be automatically updated by the system.

9. Remote Coaching System according to claim 1, further comprising selecting by the user an Instructional Unit (IU) and carrying out by the user a practice activity.

10. Cross-Platform Coaching System and Service enabling recording, monitoring and analysis of personal nutritional behavior and increasing of general nutritional awareness comprising:
1—creating a profile for each user;
2—simulation of hypotetical bodily changes;
3—providing instruction as for key subjects relate to the service means for acquiring said information in a wide range of formats;
4—database with user data, food data, daily consumption data and personal history data;
5—methods for displaying said data;
6—database that is editable differentially by service users, administrator and food providers/manufacturers;
7—means for adding a food item by food group or name to the daily consumption status and display the results;
8—method for elaborating basic nutritional information in a way that is easily understandable to the user, and especially method for weigh/volume to calories conversion and application in amount multipliers;
9—method for comparing different food items' properties prior to their consumption;
10—method for evaluating better distribution of nutrients in food items;
11—system and method for locating suitable food items;
12system and method as in 11 with positioning features like GPS;
13—system and method for administrating accumulated personal data and issuing relevant reports;
14—system and method for enabling different degrees of information's exposure.

11. System and method for monitoring the user's nutritional behavior and for issue relevant comments.

12. System and method in a wireless LAN or GPS setting according claim 10 for carrying out a food order, paying for said order after having located said item.
